(19) United States
(12) Patent Application Publication
(10) Pub. No.: US 2007/0244721 A1
(43) Pub. Date: Oct. 18, 2007

(54) Systems and methods for improved assessment and reporting of the efficacy and safety of drug, biologic, botanical, vitamin, medical food and medical device treatments

(76) Inventors: Jonathan D. Sackner-Bernstein, Dobbs Ferry, NY (US); Gary K. Zammit, Norwalk, CT (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/728,122

(22) Filed: Mar. 23, 2007

Related U.S. Application Data
(63) Continuation-in-part of application No. 11/264,706, filed on Oct. 31, 2005.

(51) Int. Cl. G06Q 50/00

(52) U.S. Cl. 705/2

(57) ABSTRACT

A system and method are described to identify risks and assess the efficacy and safety associated with drug, biologic, nutritional, medical food and medical device therapies throughout the treatment development process. The data measured are evaluated in relation to a patient's specific physiologic state (for example, data collected throughout a biological cycle) to determine the attribution to specific organ systems, functions or mechanisms, and are reported within this context. Further, the system and method enable real time access and entry of patient data stored in a centralized database via the internet or other computing device.

### CROSS-REFERENCE TO RELATED APPLICATIONS

This application is a continuation-in-part of co-pending application entitled “Methods And Systems For Web Based Centralized Patient Assessment,” Ser. No. 11/264,706, filed Oct. 31, 2005, by inventor Gary K. Zammit, the entirety of which is hereby incorporated herein by this reference.

### FIELD OF THE INVENTION

This invention relates to improvements in the systems and methods used to assess the efficacy and safety of drugs, biologics, botanicals, vitamins, medical foods or medical devices (hereinafter “Treatments”) at any point in their development and marketing lifecycle, and improvements in the data collection, processing, and reporting methods associated with such assessments. This invention applies to all efficacy and safety assessments (hereinafter “Assessments”), including those performed during pre-clinical and clinical stages as well as those pre and post-approval (hereinafter “Development Programs”). Even if one or more component of any Development Programs are performed outside the United States, this invention encompasses any remaining components of any Development Programs performed within the jurisdiction of the USPTO and, in addition, would include the analysis or reporting of any such analysis as delineated within this patent. Specifically, the invention involves the Assessments of Treatments while considering whether the organism is (1) awake, sleepy, or asleep (and, if asleep, the sleep stage, electroencephalographic (EEG) microstructure of sleep, EEG macrostructure of sleep, architecture of sleep), (2) active or inactive (including resting while awake, all levels of activity and measurements during exercise), and/or (3) at any particular point or phase-angle of a biological cycle or rhythm (including ultradian, circadian, and infradian rhythms), hereinafter referred to collectively as “State” or “States”. Consideration of the State of the organism under study improves the accuracy and efficiency of the Assessments, irrespective of whether the Treatments are intended for modulation of these States or not. The invention includes any oral or written report of data, results, or opinions based on the application of these methods in any public or private venue. Such venues include but are not limited to (a) scientific, educational, academic or consulting meetings (b) publication or presentations in scientific, industry, regulatory, academic, or educational materials, including books, journals, magazines, advertisements, labels, package inserts and any/all electronic formats, and (c) regulatory meetings, whether with government or private groups, including those groups/individuals responsible for or involved with regulatory activities or guideline formulation/dissemination, specifically to include any meetings or documents relevant to the review and approval process of any Treatment.

### BACKGROUND

Development Programs sponsored by pharmaceutical, biotechnology, nutrition, medical food and medical device companies (hereinafter “Sponsors”) are essential to the advancement of medicine and health care. They provide regulatory authorities with required information regarding the efficacy and safety of Treatments, including their adverse effects. Ultimately, these Development Programs identify new and alternative Treatments that are of potential value to patients and the physicians who care for them.

The current approaches to drug development are based on standards that have evolved over the past 80 years, many of which have become regulated by Federal law. These standards enable investigators and regulatory authorities to make Assessments of Treatments under investigation in an organized manner. However, the history of therapeutic product development is marked by many instances in which incorrect conclusions were reached regarding the efficacy or safety of Treatments. Treatments have appeared useful and subsequently were proven not to be so. Treatments that appeared safe were found to be dangerous. Treatments may be ineffective or dangerous in one group while beneficial in another and vice versa.

A primary objective of Development Programs is to determine Treatment efficacy. Current regulatory guidelines require that test results meet certain minimal criteria in order for Treatments to be considered approvable. However, the Assessments generally fail to consider the States of the animals or humans under study (with the exception of Treatments under development for sleep/circadian rhythm disorders/diseases/conditions or for exercise-induced respiratory and/or cardiovascular disorders/diseases/conditions). These Assessments do not consider if the organism is: awake, sleepy, or asleep (and, if asleep, the sleep stage, electroencephalographic (EEG) microstructure of sleep, EEG macrostructure of sleep, and architecture of sleep); active or inactive (with the exception of Treatments in Development Programs intended to improve exertional measures, such as in chronic obstructive lung disease, angina pectoris, heart failure and/or peripheral arterial disease, where outcome measures are treadmill, bicycle and/or walking tests); or the biological phase or phase angle at which the therapeutic effect may occur. This may lead to inaccurate conclusions regarding the efficacy of Treatments. For example, an antihypertensive drug producing markedly reduced blood pressure could be harmful if the reductions proved excessive when patients are asleep and inactive, even if such reductions were evident only in a subgroup of people treated with the medicine.

Another primary objective of Development Programs is to determine Treatment safety. As is the case for efficacy Assessments, current approaches to safety testing do not specifically or explicitly consider the physiological status of the subjects under investigation in a complete or intentional manner. These approaches typically disregard the measurement of physiological state: if the organism is awake, sleepy, or asleep (and, if asleep, the sleep stage, electroencephalographic (EEG) microstructure of sleep, EEG macrostructure of sleep, architecture of sleep), active or inactive, or the time or biological phase or phase angle at which the adverse experience occurs. This can result in incorrect conclusions regarding the safety of a treatment. For example, if the safety of an antidepressant medication is assessed only during wakefulness, its effects on sleep or on other physiological functions (e.g., heart rate, rhythm and/or cardiac repolarization/QT intervals on electrocardiogram) during sleep will not be known, possibly resulting in a limited understanding of the risks associated with the medication. Studies have shown that there are changes in cardiac repolarization during sleep, changes that relate to the sleep state and the specific stage of sleep, as well as to the phase of the biologic rhythm (as reflected by QT and QTc intervals on the electrocardiogram as well as QT dispersion, measured from the electrocardiogram).

As another example, when assessing the efficacy of a drug for cognitive functioning, all subjects who are awake should not be considered in the same state. Some may have cognitive performance impaired as a result of being sleepy. Therefore, a subject's level of sleepiness as a measure of physiological status, which has generally been ignored, should not be disregarded.

In the Assessment of Treatments, prior art fails to take into account variations in the States of the animal or human under study. Therefore, it is desirable that systems and methods allow data obtained from any and all components of the Development Programs to be evaluated in relation to an organism's specific physiologic state in order to optimally perform Assessments of any Treatment and to report and utilize the results thereof.

A further objective of the invention is to provide systems and methods that enable remote data capture or data entry obtained from the Development Programs, and the collection of the data in a centralized database. Generally, the use of centralized data processing services is common in Development Programs. In their simplest forms, such services are used for the processing of paper case report forms (CRFs). However, they also have been used in more complex circumstances, such as the handling of biological samples or physiological data. Centralized data processing generally allows data to be acquired in a standardized manner and processed at a single location using uniform and reliable methods. Development Programs commonly employ centralized data services for the processing of radiographic or other image data collected in multicenter studies.

Centralized data processing methods have been used in the acquisition and analysis of electronic (digital) data. This trend has gained acceptance in the pharmaceutical industry. However, most electronic data handling methods simply provide a digital alternative to traditional paper handling methods, exploiting common advantages of the electronic environment (e.g., “cut & paste” and other electronic manipulation techniques). Therefore, it would be desirable to provide systems and methods which enable electronic data from Development Programs to be collected, handled, and transferred in a highly controlled manner. It would further be desirable that the electronic data transferred to a central data processing facility is handled, processed, analyzed, and archived in a highly controlled manner. It would be of further advantage that the system is compliant with Federal regulations regarding the handling of clinical and clinical trial data.

### BRIEF SUMMARY OF THE INVENTION

The invention provides a system and method to assess the efficacy and safety of the Treatments for human and/or animal disease. The system and method may be applied at any phase of the Treatment Development Program, from pre-clinical studies with animals to clinical studies with human subjects. This system and method focuses on the Assessment of organ system and/or organism function within the context of the physical and/or physiologic State of the organism. In one embodiment of the invention, an assessment of the organism's state of sleep or wakefulness, stage of sleep, EEG microstructure of sleep, EEG macrostructure of sleep, architecture of sleep, or other sleep characteristics; level of activity; and point or phase angle relative to any ultradian, circadian, or infradian biological rhythm are critical elements of the Assessment of any/all Treatments, including but not limited to the effects on and/or between the nervous, cardiovascular, respiratory, pulmonary, renal, hepatic, immune, hematologic, dermatologic, musculoskeletal and/or other physiologic or organ systems, including as well oncologic/neoplastic potential/environments for each of these listed and any others.

The data obtained are evaluated in relation to a patient's specific physiologic state (for example, data collected at a specific time point or phase angle of the biological cycle) to determine their relationship to treatments administered or to the functioning of one or more organ systems. Further, the system and method enable entry, access and retrieval of patient data stored in a centralized database via the internet or other device, including computers, personal digital assistants, telephones, facsimile machines, medical devices, or other analog or digital devices.

### DESCRIPTION OF THE DRAWINGS

FIG. 1 is a diagram of the measurement techniques and states within which measurements are performed, each contributing individually as well as in any and all combinations to permit determination and reporting thereof of safety and/or efficacy of any and all Treatments.

FIG. 2 is a block diagram of a system providing electronic data acquisition and processing for centralized patient assessment in accordance with one embodiment of the invention.

### DETAILED DESCRIPTION

Various exemplary embodiments are described with reference to the drawings. Elements of like structures or function are represented with like reference numerals throughout the drawings. The drawings are only intended to facilitate the description of specific embodiments of the invention and are not intended as an exhaustive description of the invention or as a limitation on the scope of the invention. In addition, an aspect described in conjunction with a particular embodiment is not necessarily limited to that embodiment and can be practiced in conjunction with any other embodiments of the invention.

1. Improved Assessment of Treatments

The present disclosure refers to Treatments, which is meant to include biologics, which encompasses cell, genetic and immunologic as well as protein therapies, botanicals, vitamins, medical foods, drugs and devices, including any agents or objects or combinations thereof developed (or intended to be developed) to diagnose or treat any animal or human disease.

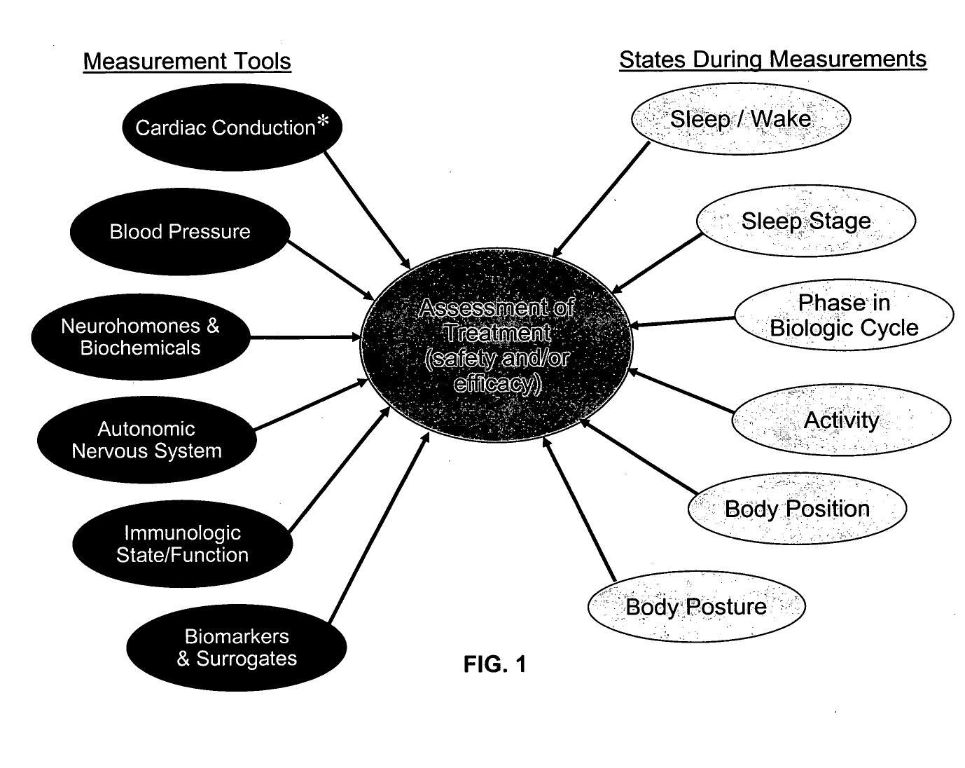

FIG. 1 shows a diagram of the measurements and those States used in the Assessment of Treatment in one embodiment of the invention. The measurement tools are exemplary of the broad range of possibilities, including those identified and those to be identified, which either alone or in some combination, would be measured, analyzed and reported as reflections of safety and/or efficacy of any and all Treatments.

A key component in the understanding of any Treatment includes measuring a variety of patient physiologic, biochemical, neurohormonal or clinical data as well as any currently identified or to be identified biomarkers or surrogates, in the context of the specific environment present. Such an approach has not to date become standard, and is a component of an embodiment of the invention. By reference to the environment, it is intended to represent both the biologic environment, in terms of genetic issues, co-morbidities, age and gender, and the physical environment, representing external stressors. In both cases, the biologic and physical factors exert influence over the organism as modulated by the effects inherent biologic rhythms, including circadian and sleep/wake, with the former including the level of sleepiness, and the latter including sleep stage/type.

Several factors underscore the relevance of investigating the effects of a treatment with an understanding of the physiological status of the organism under study and thus, the interaction between organ systems based on the organism's State.

First, treatments administered to animals or humans are far more likely to affect multiple organs and physiological processes than are they to affect only one. For example, an antibody or virally mediated therapy that appears specific to one cell type is likely to affect the immune system, thereby having secondary widespread effects.

Second, the functioning of one organ system, or its response to a treatment, may affect another organ system; with the integrated physiologic effects of one fully understood only when considered in terms of the physiology of both the individual components and the whole. As an example, the central nervous system (CNS) controls heart rate and blood pressure, yet Development Programs of therapeutics for blood pressure treatment do not routinely assess the interaction between these systems. Therefore, the status of the CNS may have an impact on any and/or all Assessments of Treatments for heart rate and blood pressure abnormalities, and may influence the Assessments of such Treatments affecting heart rate and/or blood pressure.

Third, the physiologic status of any organ system varies based on the modulation of their function/interaction with such factors as: time within the biological rhythm, presence/severity of co-morbidities, age, gender and race, amongst others. Due to the decreased drive by the central nervous system during sleep, blood pressure and heart rate tend to drop, with the later causing changes in specific electrocardiographic intervals, meaning that the heart may actually be more prone to arrhythmic risks while asleep.

Fourth, within specific sleep stages there are changes in cardiac repolarization (QT interval as well as the use of any approach, either by formula or method, that corrects QT for heart rate, as well as measurements of QT dispersion and/or T wave altemans), blood pressure, autonomic nervous system state (both changes in sympathetic and parasympathetic components in both independent and interdependent manners), neurohormonal and immune function (with differences noted in immune activation, noted in states of sleep deprivation and/or shifts in phase of biologic rhythm).

A system and method for assessing physiologic function in Treatment Development Programs can be implemented in several embodiments. In one embodiment of the invention, attention is paid to the integration of function between organ systems. This interaction between organ systems is relevant to this invention both within and independent of the context of sleep and/or sleep stage. In another embodiment of the invention, a salient feature of the subject methods includes the interaction between the biological rhythm and the Assessments made in Treatment Development Programs. Although not limited to a specific type of interaction, one example is the measurement of heart rate (or heart period) variability as a measure of interaction between the neurologic and cardiovascular systems and one that varies in a circadian fashion.

Clinical effects of a drug would be expected to vary according to the State of the organism. More specifically, for example, the risk of myocardial infarction is highest in the early morning hours, related to biological rhythm as well as cyclic biological changes in the risk of forming blood clots. This observation relates to changes in posture (as one awakens) as well as the early morning surge in the stress hormones (cortisol, adrenaline, etc.).

The unrecognized importance of biological influences on clinical risks is exemplified by the implementation of the FDA guidance (ICH E14 Guidelines, October 2005) focused on identifying cardiovascular risk. This industry guidance document establishes a standard for measurement of the effect of a drug on cardiac repolarization, a surrogate for the likelihood of life-threatening arrhythmias. During sleep, as heart rate and blood pressure drop, the repolarization period (QT interval) prolongs, which in extreme cases caused by a drug would be considered a strong indicator that arrhythmic risks are likelier, a crucial safety signal in the development process. Despite this risk, current standards of safety assessment do not include consideration of these observations.

Sleep/wake state, sleep stage and the phase in the biologic cycle each can affect systems differently as a function of gender. In one embodiment of the invention, the improved Assessment encompasses both overall effects as well as those effects found to be specific in character or magnitude as a function of gender.

Relationships between Assessments and their utility may be affected by many demographic parameters in addition to the role of gender. In another embodiment of the invention, the improved Assessment encompasses any observed differences in character or magnitude of the utility of any of these Assessments as it/they may relate to any/all demographic parameters, including but not limited to age, race, comorbidity and/or medical history.

The Assessment of the effects on cardiac arrhythmic risk is typically performed when convenient, during the daytime, when the biologic system and specifically the interaction between the central nervous and cardiovascular systems are at one extreme. In one embodiment of the invention, the subject methods assess the effects of a drug at night, which would increase the amount of information/insight about the effects of the drug on cardiac repolarization and therefore risk. Thus, in one embodiment of the invention, the improved Assessment includes the measurements of cardiac repolarization (by measurement of QT interval—and all formulas and methods for correcting for heart rate, as well as QT dispersion and T wave altemans) during sleep. In another embodiment of the invention, the improved Assessment includes measurements during specific stages of sleep. In another embodiment of the invention, the improved Assessment includes measurements during specific stages/states of wakefulness, including whether a subject is alert or sleepy. In yet another embodiment of the invention, the improved Assessment includes measurements at specific phases of the biologic cycles of organisms.

Blood pressure measurement is another target for Assessment of Treatments in Development Programs. Normal variation of blood pressure is biological in nature, yet therapies are typically assessed by measurement of blood pressure at one point in time during the day or as a 24 hour average. The lack of focus on the normal variance in this biologic measure is made worse when considering that the control of the circulation (i.e., blood pressure and heart rate) varies as a function of sleep and sleep stage/type. Thus, in one embodiment of the invention, the Assessment includes the effects of any Treatment on blood pressure during sleep. In another embodiment of the invention, the Assessment includes the measurements during specific stages of sleep. In another embodiment of the invention, the Assessment includes measurements during specific phases of the biologic cycles of organisms. In yet another embodiment of the invention, the Assessment includes measurements during specific stages/states of wakefulness, including whether a subject is alert or sleepy.

Neurohormonal and biochemical state is correlated with disease severity and Treatment effects. Neurohormones and biochemicals including those with cardiac, adrenal, metabolic, pulmonary, hepatic and renal effects, including but not limited to melatonin, cortisol, adrenaline, noradrenaline, renin, angiotensin, IL-6, TNF-alpha, thomboxane, prostacyclin and NO (and its related molecules) are affected by sleep/wake state, sleep stage and phase of biologic rhythm. In one embodiment of the invention, the Assessment of Treatments utilizes any of these or other neurohormonal biomarkers, wherein there are effects of sleep/wake, sleep/wake stage or biologic phase on their release, metabolism or effects. In another embodiment of the invention, the improved Assessment includes any and all neurohormonal and/or biochemical biomarkers that aid Assessment of Treatments (as well as diagnostic uses for human and/or animal disease/disorder).

Autonomic nervous system balance and the relative activity of the sympathetic and parasympathetic components are modulated by an organism's State, specifically whether asleep, sleepy, or awake, the sleep stage and the phase in the biologic cycle. In one embodiment of the invention, the Assessment includes the use of any measure of autonomic balance for use in Assessments of Treatments, wherein there are effects of sleep/wake, sleep/wake stage or biologic phase on their release, metabolism or effects. In another embodiment of the invention, the Assessment uses any and all measures of autonomic balance that aid Assessment of Treatments (as well as diagnostic uses for human and/or animal disease/disorder).

Immune system function is affected by presence of sleep, stage of sleep and phase in the biologic cycle. In one embodiment of the invention, the Assessment includes the use of any measure of immune function for use in Assessments of Treatments, wherein there are effects of sleep/wake, sleep/wake stage or biologic phase on their release, metabolism or effects. In another embodiment of the invention, the Assessment uses any and all measures of immune function that aid Assessment of Treatments (as well as diagnostic uses for human and/or animal disease/disorder).

In addition to these systems that are known to be affected by whether an organism is asleep or awake, as well as sleep stage and phase in biologic cycle, it is anticipated that other systems, functions and/or measures will be identified that will be affected by sleep/wake state, sleep stage and/or phase in biologic cycle. In one embodiment of the invention, the Assessment includes the use of any of biomarker or surrogate already identified for use in Assessments of Treatments, wherein there are effects of sleep/wake, sleep stage or biologic phase on their release, metabolism or effects. In another embodiment of the invention, the Assessment uses any and all biomarkers that are identified currently or yet to be identified for use in the Assessment of Treatments (as well as diagnostic uses for human and/or animal disease/disorder).

In addition to the importance of the biological rhythm on these physiologic parameters and clinical manifestations, activity levels modulate these parameters with similar importance. In another embodiment of the invention, the relationship between activity and cardiovascular parameters are fully appreciated, and the subject methods extend the assessment of the effects of therapies as a function of activity. Thus, it would be expected that a person with a more vigorous activity level would inherently increase blood pressure and likely heart rate to an extent that there may be effects in parallel on cardiac repolarization (QT interval). In addition, with the inherent variation of physiologic state that occurs both as part of the biological cycle as well as determined by sleep stage, consideration of such factors would permit assessment of blood pressure, heart rate and electrocardiographic parameters (including the QT interval, QT dispersion and T wave altemans, as well as any method subsequently defined) as they relate together or independently to biological cycle and/or sleep stage.

Development Programs that include blood pressure in the Assessment of the Treatment under investigation do not routinely include Assessments of the effects of the Treatment on blood pressure as those effects relate to activity. The normal physiologic response to increased activity is increase in blood pressure (and heart rate). Measurement of activity is typically performed by devices called actigraphs, which detect changes in movements, along with the magnitude of movement, through accelerometry. Simultaneous measurement of blood pressure and activity (by this or any other method) permit more accurate and reliable comparisons of the effects on blood pressure between measurements and between treatments. Thus, in one embodiment of the invention, the Assessment includes the recording, analysis and/or reporting of the effects on blood pressure as they relate to activity of the organism.

Development Programs that include ambulatory blood pressure in the Assessment of the Treatment under investigation do not routinely include Assessments of the effects of the Treatment on blood pressure as those effects relate to posture. The term ambulatory blood pressure refers to a method used commonly wherein blood pressure is measured intermittently while a subject is free to engage in normal activities, typically over a 24 hour period. Although patients may be instructed to sit and/or rest when the blood pressure measurement is occurring, there is no device or technique that currently measures or verifies the organism position and/or posture. Thus, in one embodiment of the invention, the Assessment includes the recording, analysis and/or reporting of the effects on blood pressure as they relate to the position and/or posture of the organism.

In one embodiment of the invention, a method is disclosed of assessing the effects of a proposed or existing therapeutic agent for the treatment of human disease that measures the effects of said agent on cardiac repolarization during sleep, with measurements derived for the individual stages of sleep, including wake/inactivity, stage 2, stage 3, stage 4 and REM, as well as any and all combinations thereof. Cardiac repolarization is hereinafter referred to and defined to include, but is not limited to, measurement of QT/QTc intervals, including currently identified correction formulas and those to be developed, QT dispersion, T-wave altemans and any and all techniques currently identified and those to be identified that provide insight into cardiac repolarization, when measured on cardiac cells, cardiac tissue or the intact organ.

In another embodiment of the invention, a method is disclosed of assessing the effects of a proposed or existing therapeutic agent for the treatment of human disease that measures the effects of said agent on cardiac repolarization during sleep, with measurements derived for any and all times within the sleep period corresponding to different phases of the biologic rhythms of the organism.

In another embodiment of the invention, a method is disclosed of assessing the effects of a proposed or existing therapeutic agent for the treatment of human disease that measures the effects of said agent on cardiac repolarization during sleep, with measurements made irrespective of body position while asleep as well as made during periods when subjects/patients are in specific body positions.

In another embodiment of the invention, a method is disclosed of assessing the effects of a proposed or existing therapeutic agent for the treatment of human disease that measures the effects of said agent on cardiac repolarization during the night, both when asleep and awake, including both spontaneous and intentional awakenings, with awakenings determined based on time, sleep/wake stage or a specific physiologic state determined by physiologic measurements of cardiovascular, respiratory, neurological or other body system.

In another embodiment of the invention, a method is disclosed of assessing the effects of a proposed or existing therapeutic agent for the treatment of human disease that measures the effects of said agent on cardiac repolarization during sleep, where the sleep state may be determined from polysomnography (in a sleep laboratory, hospital center, other medical facility or a residential setting), processing of biologic signals other than those used for a full polysomnographic study, predictive tools or arbitrarily set times.

In another embodiment of the invention, a method is disclosed of assessing the effects of a proposed or existing therapeutic agent for the treatment of human disease that measures the effects of said agent on cardiac repolarization during sleep where the gender-specific effects are of interest, as well as any/all other demographic characteristics of interest, including but not limited to age, race, comorbidity and/or medical history.

Additional measurements from an electrocardiogram may be found to be useful Assessment methods, whether focused upon cardiac conduction, depolarization, repolarization or arrhythmic risk. Cardiac conduction refers to electrical conduction of the heart and its constituent cells, including depolarization and repolarization.

2. Centralized Patient and Treatment Assessment in Development Programs

The system and methods for handling and processing electronic clinical trials data at a centralized site is described in U.S. patent application Ser. No. 11/264,706, entitled “Methods and Systems for Web Based Centralized Patient Assessment,” which is incorporated herein by reference in its entirety.

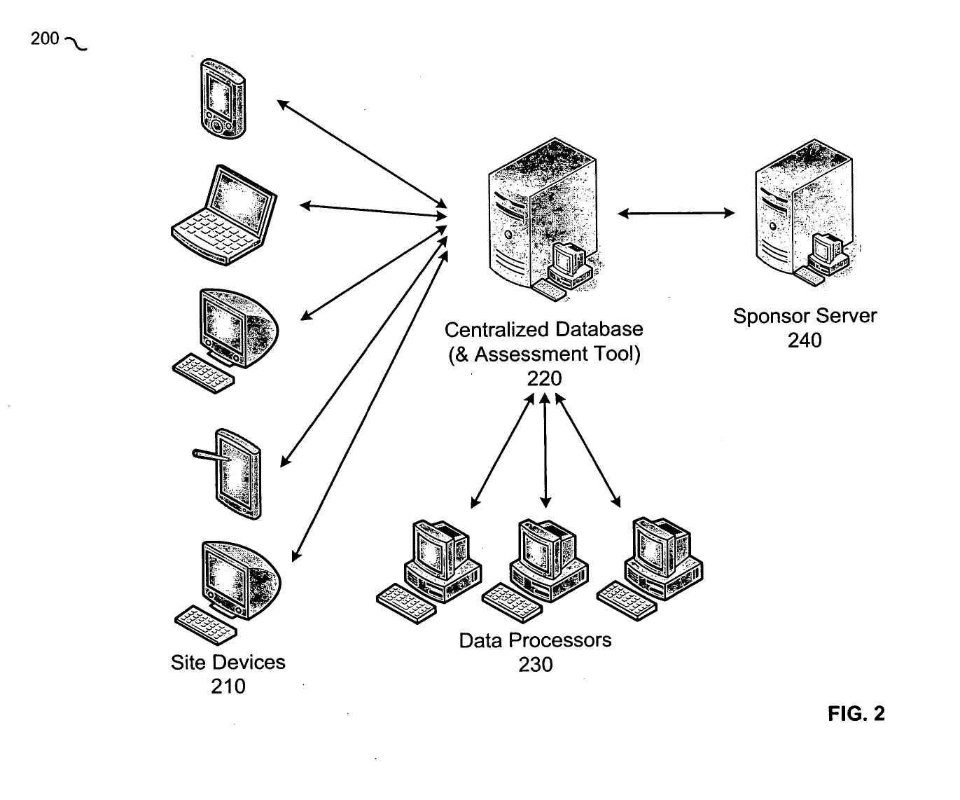

FIG. 2 is block diagram of a system 200, depicting a system for providing electronic data acquisition and processing of centralized patient data and subsequent assessment in accordance with one embodiment of the present invention.

Using an electronic interface on devices 210 either connected directly to the Internet, or using a program that can be connected to the Internet subsequently, forms will capture all the material necessary for centralized and automated Assessment. These devices include, but are not limited to computers, personal digital assistants, telephones, facsimile machines, medical devices, or other analog or digital devices. The forms and data are sent to centralized database (and assessment tool) 220. The Assessment will be complete immediately in most cases, and where not possible, will request additional information in real time and/or refer the information for clinician or physician review (over-reading, interpretation and/or adjudication). The system will facilitate input of images by investigatory sites or directly from the subject (and/or appointed representative of subject).

Forms will be selected by sponsor with or without input from investigators and/or regulatory agencies. The system will include modules relating to all therapeutic areas and which can be applied to any type of side effect or clinical event. While standard vocabularies will be used, based on regulatory and marketplace standards, the system will be customizable for any language on the interface, according with the globalization of drug/biologic/device development.

Based on the therapeutic arena, the investigator expertise, and other specific factors individualized for each participating entity, the forms will be customizable, though the standard data elements and vocabulary will be standard. Suggested algorithms for Assessment of effects will be provided as defaults, with those algorithms customizable by the sponsor/investigators, all with audit trail active.

The standard operating procedures required by sponsors determine how data processors 230 collect, handle, process, analyze, transfer, and archive datasets for each sponsor and/or clinical site. The databases can then be submitted to regulatory authorities for aggregate analyses in a fashion that complements the audits and validations of the data within the case report forms of a trial. This will parallel the ECG warehouse strategies already in place for the assessment of QT intervals, and places the system in compliance with Federal regulations regarding the handling of clinical and clinical trial data.

Information flows from site devices 210 to the central database 220, but can do so in several different manners. In some studies, information is reported to a sponsor's safety unit and submitted to sponsors electronically to sponsor server 240 in the form of adverse events and side effects while in parallel, similar but not necessarily the same data are being reported to central database 220. In post marketing setting, all data are reported to the sponsor's safety unit and sponsor serer 240. Data elements may be defined in the process of implementing a clinical trial but are typically reported in prose format as Assessments when in the post approval phase.

What is claimed is:

1. A method for improved assessment of medical treatment of disease, comprising:
obtaining from a subject one or more measurements of the effects of said medical treatment;
selecting at least one physiologic state during which said measurements are taken; and
determining based on said measurements the safety and efficacy of said medical treatment.

2. The method of claim 1, wherein the physiological states are comprised of said subject's awake state, asleep state, sleep stage, architecture of sleep, active state, inactive state, level of activity, level of sleepiness, and phase in biological cycle.

3. The method of claim 2, further comprising:
measuring a subject's posture or position as a basis for determining the safety and efficacy of said medical treatment.

4. The method of claim 2, wherein the level of activity is measure by actigraphy, calorimetry, or other measure of energy expenditure.

5. The method of claim 2, wherein the architecture of sleep is further comprised of electroencephalographic (EEG) microstructure of sleep and EEG macrostructure of sleep.

6. The method of claim 2, wherein the phase in biological cycle is further comprised of ultradian, circadian, and infradian rhythms.

7. The method of claim 1, wherein said measurement is a measure of cardiac conduction.

8. The method of claim 1, wherein said measurement is a measure of blood pressure.

9. The method of claim 1, wherein said measurement is a measure of neurohormones and biochemicals.

10. The method of claim 1, wherein said measurement is a measure of autonomic nervous system balance.

11. The method of claim 1, wherein said measurement is a measure of immune function.

12. A system for centralized assessment of treatment development program data, comprising:
at least one development program server comprising at least one development program database and assessment analysis software module operative to analyze treatment development program data stored in the at least one development program database;
at least one development program site located at a secure network location and including at least one site device for collection of development program data; and
a communications link providing communication between the at least one development program server and the at least development program site.

13. The system of claim 12, wherein the development program data is comprised of at least one physiologic state during which said measurements are taken.

14. The system of claim 13, wherein the physiological states are comprised of a subject's awake state, asleep state, sleep stage, architecture of sleep, active state, inactive state, level of activity, level of sleepiness, and phase in biological cycle.

15. The system of claim 12 further comprising a sponsor server located at a secure network location capable of receiving treatment development program data and treatment analysis from said development program database.

16. The system of claim 12 further comprising one or more data processors in communication with said development program database capable of collecting, handling, processing, analyzing, transferring, and archiving treatment development program data.

17. The system of claim 12 wherein the secure network location comprises a website.

18. A method for improved assessment of medical treatment of disease, comprising:
obtaining from a subject one or more measurements of the effects of said medical treatment;
selecting at least one physiologic state during which said measurements are taken;
providing a secured network site device for a user to input measurements from said subject;
establishing a communications link between the site device and a central database;
transferring the measurements to said central database;
analyzing the measurements; and
determining based on said measurements the safety and efficacy of said medical treatment.

19. The method of claim 18, wherein the physiological states are comprised of said subject's awake state, asleep state, sleep stage, architecture of sleep, active state, inactive state, level of activity, level of sleepiness, and phase in biological cycle.

20. The method of claim 19, further comprising:
measuring a subject's posture or position as a basis for determining the safety and efficacy of said medical treatment.

21. The method of claim 19, wherein the level of activity is measure by actigraphy, calorimetry, or other measure of energy expenditure.

22. The method of claim 19, wherein the architecture of sleep is further comprised of electroencephalographic (EEG) microstructure of sleep and EEG macrostructure of sleep.

23. The method of claim 18, wherein the phase in biological cycle is further comprised of ultradian, circadian, and infradian rhythms.

24. The method of claim 18, wherein said measurement is a measure of cardiac conduction.

25. The method of claim 18, wherein said measurement is a measure of blood pressure.

26. The method of claim 18, wherein said measurement is a measure of neurohormones and biochemicals.

27. The method of claim 18, wherein said measurement is a measure of autonomic nervous system balance.

28. The method of claim 18, wherein said measurement is a measure of immune function.
